(19) United States
(12) Patent Application Publication
(10) Pub. No.: US 2016/0105400 A1
(43) Pub. Date: Apr. 14, 2016

(54) APPARATUS AND METHODS FOR DATA TRANSFER BETEWEEN A PLURALITY OF USER DEVICES

(71) Applicant: Time Warner Cable Enterprises LLC, New York, NY (US)

(72) Inventor: Albert Straub, Westminster, CO (US)

(21) Appl. No.: 14/510,053

(22) Filed: Oct. 8, 2014

(51) Int. Cl. H04L 29/06

(52) U.S. Cl. CPC H04L 63/0428; H04L 63/062

(57) ABSTRACT

Methods and apparatus for transferring data (such as for example media or other content) between devices while maintaining protection of the content. In one embodiment, a first user device causes a network entity to generate a shared encryption key for a second user device which is to receive content. In this manner, when the content (which has been encrypted with a key that is specific to the first device) is re-encrypted using the shared key, then transferred to the second device, the second device also obtains the shared key and uses it to decrypt the content, then the second device re-encrpyts the content with a key that is specific to the second device for storage thereon. For example, within a premises network the entire contents of a first digital video recorder (DVR) may be transferred to a replacement DVR.

### RELATED APPLICATIONS

This application is related to co-owned, co-pending U.S. patent application Ser. No. 12/901,417 filed on Oct. 8, 2010 and published as U.S. Patent Application Publication No. 2012/0089699 on Apr. 12, 2012 and entitled “APPARATUS AND METHODS FOR ENFORCING CONTENT PROTECTION RULES DURING DATA TRANSFER BETWEEN DEVICES”; co-owned, co-pending U.S. patent application Ser. No. 13/608,969 filed on Sep. 10, 2012 and published as U.S. Patent Application Publication No. 2013/0070922 on Mar. 21, 2013 and entitled “TECHNIQUE FOR SECURELY COMMUNICATING AND STORING PROGRAMMING MATERIAL IN A TRUSTED DOMAIN”; and co-owned, co-pending U.S. patent application Ser. No. 13/674,866 filed on Nov. 12, 2012 and published as U.S. Patent Application Publication No. 2013/0104162 on Apr. 25, 2013 and entitled “TECHNIQUE FOR SECURELY COMMUNICATING AND STORING PROGRAMMING MATERIAL IN A TRUSTED DOMAIN”, each of which is incorporated herein by reference in its entirety.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND

1. Technological Field

The present disclosure relates generally to the field of data (for example, media data or other content) management over a network. More particularly, the present disclosure is related in one exemplary aspect to apparatus and methods for delivering or distributing data between a plurality of user devices, and protection of the data.

2. Description of Related Technology

Recent advances in digital information processing and technology have made a range of services and functions available for delivery to consumers at their premises for very reasonable prices or subscription fees. These services and functions include digital content or programming (movies, etc.), digital video-on-demand (VOD), personal video recorder (PVR) and networked PVR (nPVR), Internet Protocol television (PTV), digital media playback and recording, as well high speed Internet access and IP-based telephony (e.g., VoIP). Other services available to network users include access to, and recording of, digital music (e.g., MP3 files), as well as local area networking (including wire-line and wireless local area networks) for distributing these services throughout the user's premises, and beyond. Network-delivered or network-based gaming and applications (“apps”) have also each recently come to the forefront as popular content areas for users.

Currently, many of these services are provided and delivered to the users via a wide variety of different equipment environments including, inter alia, cable modems, Wi-Fi® hubs, Ethernet hubs, gateways, switches and routers, computers, servers, cable or satellite networks and associated set-top boxes, and PSTNs.

Recent advances in consumer electronics have also led to the widespread introduction of a variety of portable media devices (PMDs) such as, inter alia, portable digital music devices, cellular telephones/smart phones, handheld computers, laptop computers, netbooks, and personal digital assistants (PDA), which allow users to store and playback audio and video files. Various digital audio and video formats are utilized by PMDs. For example, MP3 players store a number of digitized audio files in the form of MP3 files which are then made accessible to the user. Additionally, the services associated with such technology are typically provided by multiple vendors including e.g., a cable service provider (multiple systems operator or MSO), cellular service provider (CSP), wireless service provider (WSP), VoIP service provider, music download service, “app” stores, game vendors, Internet service provider (ISP), PSTN telephone service, etc.

The myriad of services, equipment, data formats and providers can easily create confusion for a user, as often the equipment or services may not interoperate with one another, thus reducing the overall utility provided to the user, and increasing their frustration level.

Accordingly, playback of audio and video files is often limited to playback only on the device on which the content is stored. In other words, a user may only select audio and video files from a device to be played back to the user on that same device. Thus, if a user stores video content at e.g., a premises device such as a storage apparatus associated with a television set-top box, the user is limited to viewing the content on a display associated with the premises and in communication with the storage apparatus.

Current apparatus fail to provide users with the ability to move content stored on a device associated with a first device to a second device (such as a personal mobile device or PMD) while also obeying any restrictions on utilizing, copying and/or distributing the content. That is to say, the use and/or transfer of content stored on a first device must adhere to various rules or conditions. For example, content sources or generators and providers/distributors generally agree on restrictions on the use (e.g., number of plays, and by whom), reproduction, and/or transfer of digital content. In addition, there may be legally-based copyright rules or restrictions that regulate whether archival copies can be made, how many copies can be made, whether protective data such as DRM, watermarking, etc. must be included in the copy process, and how any copies that are made are managed, etc. Additionally, various rules may be instituted by a service provider regarding a particular user's rights with respect to copying, using, and/or distributing content. Under currently implemented systems, a customer is prohibited in many instances from making content stored at a user premises device available to more than one device connected thereto, while continuing to enforce the aforementioned copyright or other protection rules.

Furthermore, content conditional access (CA) paradigms currently in use are often quite restricted, and not generally extensible beyond the user's gateway, terminal, or cable/satellite set-top box. So, for example, the user would be prohibited from transferring streamed or downloaded content to their Wi-Fi enabled laptop or PC, since proper conditional access support—e.g., that associated with their host terrestrial (e.g., cable or fiber) or satellite network—does not exist in these devices.

The foregoing problems are compounded when a user replaces a device which has content and/or data stored thereon. In certain instances it is simply not possible to have the data stored on a first device transferred in whole or in part to a second device.

Therefore, improved apparatus and methods for distributing digital data and services between devices, while still adhering to content protection (e.g., copyright) rules for the data/content, are needed.

### SUMMARY

The present disclosure addresses the foregoing needs by disclosing, inter alia, apparatus and methods for content and/or data transfer between a plurality of user devices.

The present disclosure addresses the foregoing needs by disclosing, inter alia, apparatus and methods for data transfer and management between a plurality of user devices.

In a first aspect of the disclosure, a method of providing content from a first user device to a second user device is disclosed. In one embodiment, the content is associated to e.g., the first device, and the method includes: (i) based at least on the occurrence of a triggering event, requesting a transfer key for the transfer of the content from the first to the second device, (ii) receiving the transfer key, (iii) decrypting the content using a first key which is specific to the first device, (iv) re-encrypting the content using the transfer key, and (v) transferring the content to the second device. The second device is, in one implementation, configured to decrypt the content using the transfer key, and re-encrypt the content using a second key which is specific to the second device.

In a second aspect of the disclosure, a consumer premises device (CPE) configured to provide protected content to a client device in communication therewith is disclosed. In one embodiment, the CPE comprises a first interface configured to receive the protected content from a network, a storage device, a processor in data communication with the interface and storage device; and a second interface configured to transmit the protected content to the client device. The processor is configured to run at least one computer application thereon. In one variant, the application is configured to: (i) based on at least the occurrence of a triggering event, request a transfer key from a network entity, (ii) receive the transfer key, (iii) decrypt the content using a first key which is specific to the CPE, (iv) re-encrypt the content using the transfer key, and (v) transfer the content to the client device.

In a third aspect of the disclosure, a method of providing content from a first user device to a second user device is disclosed. In one embodiment, the method comprises: (i) receiving a request to generate a content transfer key from the first user device, (ii) authenticating the first user device, (iii) creating the content transfer key, and (iv) enabling the first user device to access the content transfer key, the first user device being configured to use the content transfer key to transcrypt the content from a first format specific to the first user device, to a second transfer format.

In another variant, the method further comprises: (i) receiving a request to access the content transfer key from the second user device, (ii) authenticating the second user device, and (iii) enabling the second user device to access the content transfer key, the second user device being configured to use the content transfer key to transcrypt the content from the second transfer format to a third format specific to the second user device.

In a fourth aspect of the disclosure, a content transfer manager apparatus configured to enable content to be transferred from a first to a second client device is disclosed. In one embodiment, the content transfer manager apparatus comprises a first interface configured to receive the content from a content source, a storage device, a digital processor, the processor configured to run at least one computer program thereon. In one variant, the program is configured to: (i) receive a request to generate a content transfer key from the first client device, (ii) authenticate the first client device, (iii) create the content transfer key, and (iv) enable the first client device to access the content transfer key, the first client device being configured to use the content transfer key to transcrypt the content from a first format specific to the first client device, to a second transfer format. The content transfer manager apparatus further comprises in one variant a second interface configured to provide information regarding the content transfer key to the first client device.

In another variant, the program is further configured to: (i) receive a request to access the content transfer key from the second client device, (ii) authenticate the second client device, and (iii) enable the second client device to access the content transfer key, the second client device being configured to use the content transfer key to transcrypt the content from the second transfer format to a third format specific to the second client device.

In a fifth aspect of the disclosure, a method of receiving a plurality of content from a first user device at a second user device is disclosed. In one embodiment, the method comprises: (i) receiving the plurality of content in a first format, the first format comprising a transfer format, (ii) requesting a transfer key from a network entity, (iii) upon authentication of the second user device, receiving the transfer key, (iv) using the transfer key to decrypt the plurality of content, and (v) re-encrypting the plurality of content using a key which is specific to the second user device.

In a sixth aspect of the disclosure, a consumer premises device (CPE) configured to receive a plurality of protected content from a client device in communication therewith is disclosed. In one embodiment, the CPE includes a first interface configured to receive the plurality of protected content from the client device, a storage device, and a processor. The processor is configured to run at least one computer application thereon. In one variant, the application is configured to: (i) receive the plurality of protected content in a first format, the first format comprising a transfer format, (ii) request a transfer key from a network entity, (iii) receive the transfer key, (iv) use the transfer key to decrypt the plurality of protected content, and (v) re-encrypt the plurality of protected content using a key which is specific to the CPE.

In a seventh aspect of the disclosure, a system for transferring data between devices while maintaining a security thereof is disclosed.

In an eighth aspect of the disclosure a computer readable apparatus comprising at least one computer program for ensuring secure transfer of content between devices is disclosed.

These and other aspects of the disclosure shall become apparent when considered in light of the detailed description provided herein.

### BRIEF DESCRIPTION OF THE DRAWINGS

FIG. 1 is a functional block diagram illustrating an exemplary HFC cable network configuration useful with the present disclosure.

FIG. 1a is a functional block diagram illustrating one exemplary HFC cable network headend configuration useful with the present disclosure.

FIG. 1b is a functional block diagram illustrating one exemplary local service node configuration useful with the present disclosure.

FIG. 1c is a functional block diagram illustrating one exemplary packetized content delivery network architecture useful with the present disclosure.

FIG. 2 is a functional block diagram illustrating a distribution network architecture configured in accordance with one embodiment of the disclosure.

FIG. 3 is a logical flow diagram illustrating one embodiment of a method for content transfer between two devices in accordance with one embodiment of the disclosure.

FIG. 3a is a logical flow diagram illustrating one embodiment of a method for content transfer from a first device in accordance with one embodiment of the disclosure.

FIG. 3b is a logical flow diagram illustrating one embodiment of a method for content transfer to a second device in accordance with one embodiment of the disclosure.

FIG. 3c is a logical flow diagram illustrating one embodiment of a method for facilitating content transfer between two devices in accordance with one embodiment of the disclosure.

FIG. 3d is a logical flow diagram illustrating one embodiment of a method for managing content transfer between two devices in accordance with one embodiment of the disclosure.

FIG. 4 is a block diagram illustrating an exemplary client device for use in the present disclosure.

FIG. 5 is a functional block diagram illustrating an exemplary device for facilitating content transfer for use in the present disclosure.

FIG. 6 is a functional block diagram illustrating an exemplary device for managing content transfer for use in the present disclosure.

All Figures and Appendices ©Copyright 2014 Time Warner Cable Enterprises LLC. All rights reserved.

### DETAILED DESCRIPTION

Reference is now made to the drawings wherein like numerals refer to like parts throughout.

As used herein, the term “application” refers generally to a unit of executable software that implements a certain functionality or theme. The themes of applications vary broadly across any number of disciplines and functions (such as on-demand content management, e-commerce transactions, brokerage transactions, home entertainment, calculator etc.), and one application may have more than one theme. The unit of executable software generally runs in a predetermined environment; for example, the unit could comprise a downloadable Java Xlet™ that runs within the JavaTV™ environment.

As used herein, the term “client device” includes, but is not limited to, digital set-top boxes (e.g., DSTBs), personal computers (PCs), and minicomputers, whether desktop, laptop, or otherwise, and mobile devices such as handheld computers, tablets, personal digital assistants (PDAs), personal media devices (PMDs), and smartphones.

As used herein, the term “codec” refers to an video, audio, or other data coding and/or decoding algorithm, process or apparatus including, without limitation, those of the moving-picture experts group (MPEG) (e.g., MPEG-1, MPEG-2, MPEG-4/H.264, H.265, etc.), Real (RealVideo, etc.), Dolby® audio codec 3 (AC-3e), DiVX, XViD/ViDX, Windows Media Video (e.g., WMV 7, 8, or 9), ATI Video codec, or VC-1 (SMPTE standard 421M) families.

As used herein, the term “computer program” or “software” is meant to include any sequence or human or machine cognizable steps which perform a function. Such program may be rendered in virtually any programming language or environment including, for example, C/C++, Fortran, COBOL, PASCAL, assembly language, markup languages (e.g., HTML, SGML, XML, VoXML), and the like, as well as object-oriented environments such as the Common Object Request Broker Architecture (CORBA), Java™ (including J2ME, Java Beans, etc.), Binary Runtime Environment (e.g., BREW), and the like.

As used herein, the term “conditional access” refers to any access control scheme, whether implemented in hardware, software, or firmware (or combinations thereof), including without limitation members of the “Powerkey” family (Powerkey Book 2, Powerkey Book 3, etc.), NDS (including VideoGuard, mVideoGuard, etc.), ANSI/SCTE Standard 52 2003 (DVS-042), incorporated herein by reference in its entirety, and Motorola/General Instrument DigiCiphe® family (DigiCipher II, etc.). These can be implemented using, for example, the so-called “CableCard” plug-in security module access technology, a downloadable CA system (DCAS), or otherwise.

The terms “consumer premises equipment” (CPE) and “consumer device” refer without limitation to any type of electronic equipment for use within a consumer's or user's premises and connected to a content distribution network. The term “consumer device” includes terminal devices that have access to digital television content via a satellite, cable, or terrestrial network. The term “consumer premises equipment” (CPE) includes such electronic equipment such as set-top boxes (e.g., DSTBs or IPTV devices), televisions, cable modems (CMs), embedded multimedia terminal adapters (eMTAs), whether stand-alone or integrated with other devices, digital video recorders (DVR), gateway storage devices, and ITV personal computers.

As used herein, the term “display” means any type of device adapted to display information, including without limitation CRTs, LCDs, TFTs, plasma displays, LEDs, incandescent and fluorescent devices. Display devices may also include less dynamic devices such as, for example, printers, e-ink devices, and the like.

As used herein, the term “DVR” (digital video recorder) refers generally to any type of recording mechanism and/or software environment, located in the headend, the user premises or anywhere else, whereby content sent over a network can be recorded and selectively recalled. Such DVR may be dedicated in nature, or part of a non-dedicated or multi-function system.

As used herein, the term “DOCSIS” refers to any of the existing or planned variants of the Data Over Cable Services Interface Specification, including for example DOCSIS versions 1.0, 1.1, 2.0 and 3.0. DOCSIS (version 1.0) is a standard and protocol for interne access using a “digital” cable network.

As used herein, the terms “Internet” and “internet” are used interchangeably to refer to inter-networks including, without limitation, the Internet.

As used herein, the term “memory” includes any type of integrated circuit or other storage device adapted for storing digital data including, without limitation, ROM, PROM, EEPROM, DRAM, SDRAM, DDR/2 SDRAM, EDO/FPMS, RLDRAM, SRAM, “flash” memory (e.g., NAND/NOR), and PSRAM.

As used herein, the terms “microprocessor” and “digital processor” are meant generally to include all types of digital processing devices including, without limitation, digital signal processors (DSPs), reduced instruction set computers (RISC), general-purpose complex instruction set computing (CISC) processors, microprocessors, gate arrays (e.g., FPGAs), PLDs, reconfigurable compute fabrics (RCFs), array processors, and application-specific integrated circuits (ASICs). Such digital processors may be contained on a single unitary IC die, or distributed across multiple components.

As used herein, the terms “MSO” or “multiple systems operator” refer to a cable, satellite, or terrestrial network provider having infrastructure required to deliver services including programming and data over those mediums.

As used herein, the terms “network” and “bearer network” refer generally to any type of telecommunications or data network including, without limitation, hybrid fiber coax (HFC) networks, satellite networks, telco networks, and data networks (including MANs, WANs, LANs, WLANs, internets, and intranets). Such networks or portions thereof may utilize any one or more different topologies (e.g., ring, bus, star, loop, etc.), transmission media (e.g., wired/RF cable, RF wireless, millimeter wave, optical, etc.) and/or communications or networking protocols (e.g., SONET, DOCSIS, IEEE Std. 802.3, ATM, X.25, Frame Relay, 3GPP, 3GPP2, WAP, SIP, UDP, FTP, RTP/RTCP, H.323, etc.).

As used herein, the term “network interface” refers to any signal, data, or software interface with a component, network or process including, without limitation, those of the FireWire (e.g., FW400, FW800, etc.), USB (e.g., USB2, USB 3.0), Ethernet (e.g., 10/100, 10/100/1000 (Gigabit Ethernet), 10-Gig-E, etc.), MoCA, Coaxsys (e.g., TVnet™), radio frequency tuner (e.g., in-band or OOB, cable modem, etc.), Wi-Fi (802.11), WiMAX (802.16), PAN (e.g., 802.15), cellular (e.g., LTE/LTE-A, 3GPP, 3GPP2, UMTS), or IrDA families.

As used herein, the terms “personal media device” and “PMD” refer to, without limitation, any device, whether portable or otherwise, capable of storing and/or rendering media.

As used herein, the term “server” refers to, without limitation, any computerized component, system or entity regardless of form which is adapted to provide data, files, applications, content, or other services to one or more other devices or entities on a computer network.

As used herein, the term “user interface” refers to, without limitation, any visual, graphical, tactile, audible, sensory, or other means of providing information to and/or receiving information from a user or other entity.

As used herein, the term “Wi-Fi” refers to, without limitation, any of the variants of IEEE-Std. 802.11 or related standards including 802.11 a/b/g/n.

As used herein, the term “wireless” means any wireless signal, data, communication, or other interface including without limitation Wi-Fi, Bluetooth, 3G, HSDPA/HSUPA, TDMA, CDMA (e.g., IS-95A, WCDMA, etc.), FHSS, DSSS, GSM, PAN/802.15, Wi-MAX (802.16), 802.20, narrowband/FDMA, OFDM, PCS/DCS, analog cellular, CDPD, satellite systems, millimeter wave or microwave systems, acoustic, and infrared (i.e., IrDA).

### Overview

In one salient aspect, the present disclosure provides apparatus and methods for data transfer between a plurality of user devices. In one exemplary embodiment, a first user device causes a network entity to generate a shared encryption key for a second user device which is to receive the data (e.g., media or other content). In this manner, when the content (which has been encrypted with a key that is specific to the first device) is re-encrypted using the shared key, then transferred to the second device, the second device also obtains the shared key and uses it to decrypt the content, then the second device re-encrypts the content with a key that is specific to the second device for storage thereon. The first user device may transfer the content to any one of a number of second devices including, e.g., other consumer premises devices, media devices, smartphones, tablets, desktop or laptop computers, etc. In one implementation, the client device is also responsible for implementing, enforcing, and/or transferring one or more protection rules associated with the content.

In a further aspect of the present disclosure, the first device uses a premises (e.g., in-home) network to transfer the entire contents of a digital video recorder (DVR) associated therewith to the replacement device. Such is the case in the event of a device upgrade, for example. In this example, the user's previously recorded content is not lost due to a device upgrade. Moreover, significant resource utilization, which would be required to upload the entirety of the user's DVR to the cloud (or a network entity) and then retransmit the content back to the replacement device, is advantageously obviated. The content transfer may occur for instance within the premises network or a trusted domain, thereby allowing a user (such as a managed network subscriber) total mobility of the content within the premises network (which may in fact extend beyond the physical boundary of the premises). For example, media content from the client device may be accessed via extant networks (e.g., MoCA, Ethernet, Wi-Fi, or PAN) for distribution to any DSTB, PC, mobile device, or other PMD in the network. The client device may also utilize the existing premises network to allow other devices to share media content with it.

In another implementation, the content, rather than being copied, is merely moved from the first device to the second device. According to this implementation, the content must be moved back to the first device in order for it to become useable thereon and/or transferrable therefrom.

Various other rules may also be implemented by the host network and/or subscriber device, including those regarding a particular user's access rights, usage rights, and/or profile.

### Detailed Description of Exemplary Embodiments

Exemplary embodiments of the apparatus and methods of the present disclosure are now described in detail. While these exemplary embodiments are described in the context of the aforementioned hybrid fiber coax (HFC) cable system architecture having a multiple systems operator, digital networking capability, and plurality of client devices/CPE, the general principles and advantages of the disclosure may be extended to other types of networks and architectures, whether broadband, narrowband, wired or wireless, terrestrial or satellite, managed or unmanaged, QoS or no QoS, or otherwise, the following therefore being merely exemplary in nature.

It will also be appreciated that while described generally in the context of a consumer (i.e., home) end user domain, the present disclosure may be readily adapted to other types of environments (e.g., commercial/enterprise, government/military, multiple-dwelling unit, etc.) as well. Myriad other applications are possible.

Also, while certain aspects are described primarily in the context of the well-known Internet Protocol (described in, inter alia, RFC 791 and 2460), it will be appreciated that the present disclosure may utilize other types of protocols (and in fact bearer networks to include other internets and intranets) to implement the described functionality.

### Network—

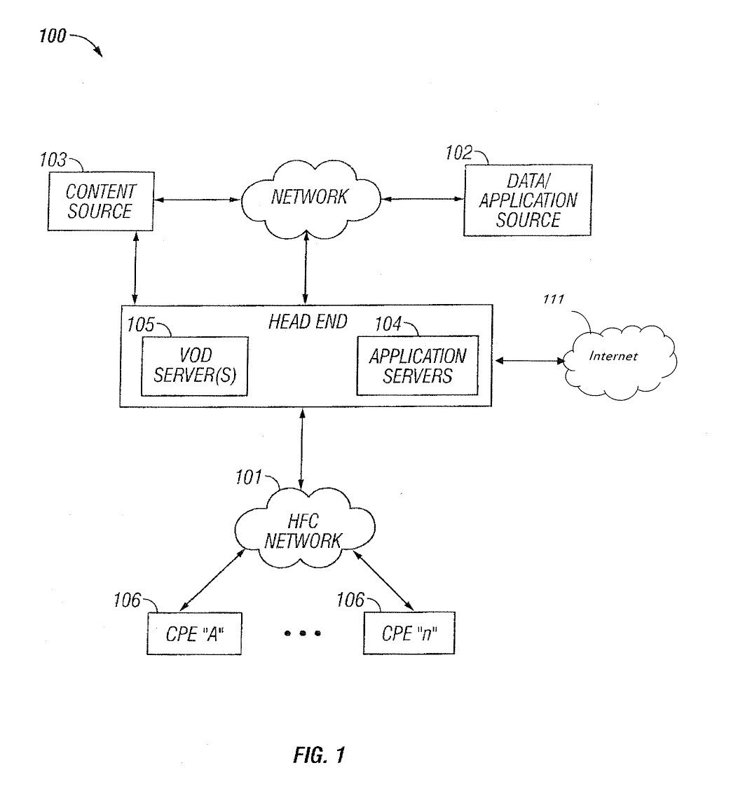

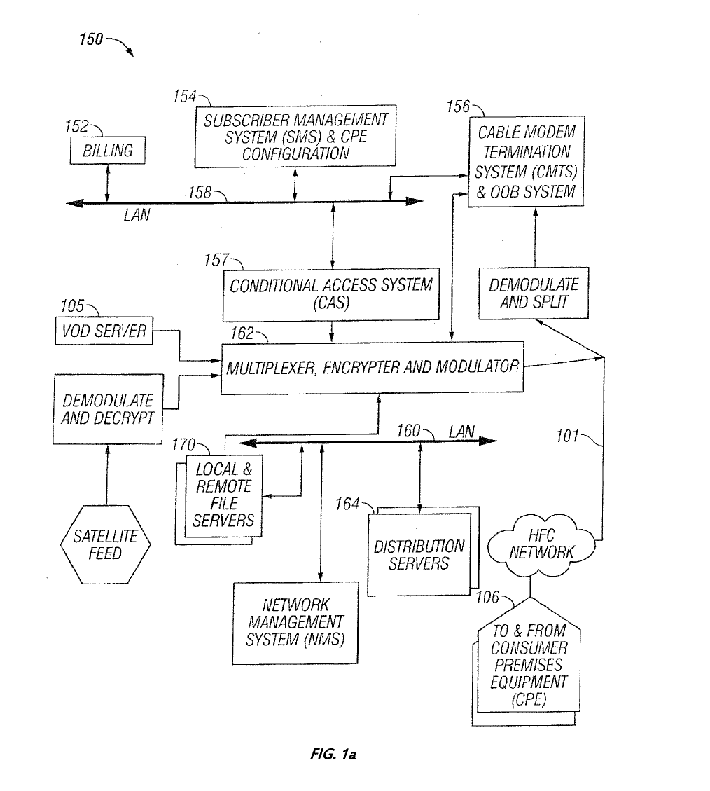

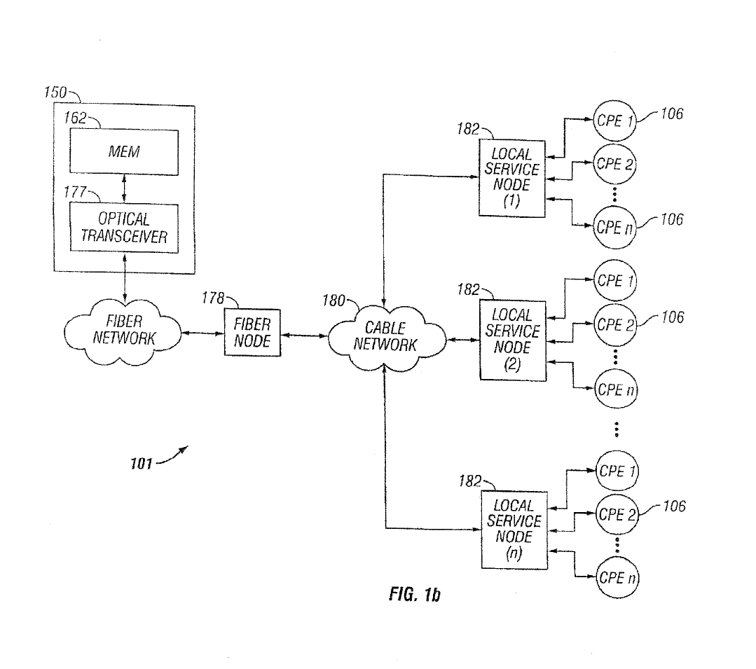

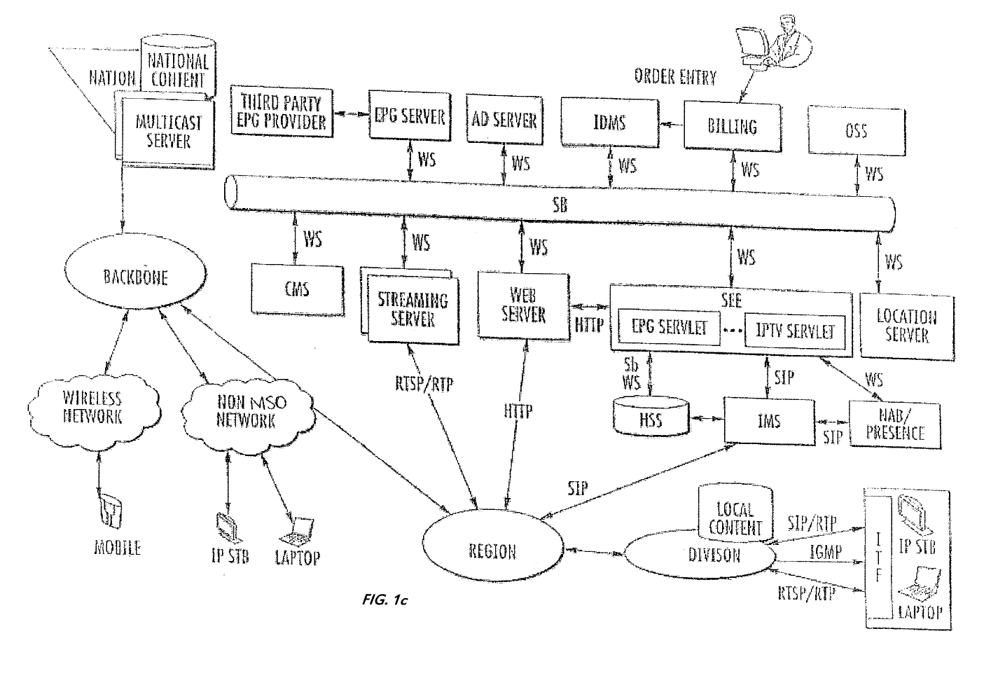

FIG. 1 illustrates an exemplary distribution network configuration with which the apparatus and methods of the present disclosure may be used. The various components of the network 100 include (i) one or more data and application origination points 102; (ii) one or more content sources 103, (iii) one or more application distribution servers 104; (iv) one or more VOD servers 105, and (v) consumer premises equipment (CPE) 106. The distribution server(s) 104, VOD servers 105 and CPE(s) 106 are connected via a bearer (e.g., HFC) network 101. A simple architecture comprising one of each of the aforementioned components 102, 104, 105, 106 is shown in FIG. 1 for simplicity, although it will be recognized that comparable architectures with multiple origination points, distribution servers, VOD servers, and/or CPE devices (as well as different network topologies) may be utilized consistent with the disclosure. For example, the headend architecture of FIG. 1a (described in greater detail below) may be used.

The data/application origination point 102 comprises any medium that allows data and/or applications (such as a VOD-based or “Watch TV” application) to be transferred to a distribution server 104. This can include for example a third party data source, application vendor website, CD-ROM, external network interface, mass storage device (e.g., RAID system), etc. Such transference may be automatic, initiated upon the occurrence of one or more specified events (such as the receipt of a request packet or ACK), performed manually, or accomplished in any number of other modes readily recognized by those of ordinary skill.

The application distribution server 104 comprises a computer system where such applications can enter the network system. Distribution servers are well known in the networking arts, and accordingly not described further herein.

The VOD server 105 comprises a computer system where on-demand content can be received from one or more of the aforementioned data sources 103 and enter the network system. These servers may generate the content locally, or alternatively act as a gateway or intermediary from a distant source.

The CPE 106 includes any equipment in the “customers premises” (or other locations, whether local or remote to the distribution server 104) that can be accessed by a distribution server 104. Content received at the CPE 106 may be recorded to a storage apparatus associated with the CPE 106 (as discussed in further detail elsewhere herein).

Referring now to FIG. 1a, one exemplary embodiment of a headend architecture useful with the present disclosure is described. As shown in FIG. 1a, the headend architecture 150 comprises typical headend components and services including billing module 152, subscriber management system (SMS) and CPE configuration management module 154, cable-modem termination system (CMTS) and OOB system 156, as well as LAN(s) 158, 160 placing the various components in data communication with one another. It will be appreciated that while a bar or bus LAN topology is illustrated, any number of other arrangements as previously referenced (e.g., ring, star, etc.) may be used consistent with the disclosure. It will also be appreciated that the headend configuration depicted in FIG. 1a is high-level, conceptual architecture and that each MSO may have multiple headends deployed using custom architectures.

The architecture 150 of FIG. 1a further includes a multiplexer/encrypter/modulator (MEM) 162 coupled to the HFC network 101 adapted to “condition” content for transmission over the network. The distribution servers 164 are coupled to the LAN 160, which provides access to the MEM 162 and network 101 via one or more file servers 170. The VOD servers 105 are coupled to the LAN 160 as well, although other architectures may be employed (such as for example where the VOD servers are associated with a core switching device such as an 802.3z Gigabit Ethernet device). As previously described, information is carried across multiple channels. Thus, the headend must be adapted to acquire the information for the carried channels from various sources. Typically, the channels being delivered from the headend 150 to the CPE 106 (“downstream”) are multiplexed together in the headend and sent to neighborhood hubs (FIG. 1b) via a variety of interposed network components.

Content (e.g., audio, video, etc.) is provided in each downstream (in-band) channel associated with the relevant service group. To communicate with the headend or intermediary node (e.g., hub server), the CPE 106 may use the out-of-band (OOB) or DOCSIS channels and associated protocols. The OCAP 1.0, 2.0, 3.0 (and subsequent) specification provides for exemplary networking protocols both downstream and upstream, although the disclosure is in no way limited to these approaches.

It will also be recognized that the multiple servers (broadcast, VOD, or otherwise) can be used, and disposed at two or more different locations if desired, such as being part of different server “farms.” These multiple servers can be used to feed one service group, or alternatively different service groups. In a simple architecture, a single server is used to feed one or more service groups. In another variant, multiple servers located at the same location are used to feed one or more service groups. In yet another variant, multiple servers disposed at different location are used to feed one or more service groups.

As shown in FIG. 1b, the network 101 of FIGS. 1 and 1a comprises a fiber/coax arrangement wherein the output of the MEM 162 of FIG. 1a is transferred to the optical domain (such as via an optical transceiver 177 at the headend or further downstream). The optical domain signals are then distributed to a fiber node 178, which further distributes the signals over a distribution network 180 to a plurality of local servicing nodes 182. This provides an effective 1:N expansion of the network at the local service end.

In addition to on-demand and broadcast content (e.g., video programming), the system of FIGS. 1a and 1b (and 1c discussed below) also deliver Internet 111 data services using the Internet protocol (IP), although other protocols and transport mechanisms of the type well known in the digital communication art may be substituted. One exemplary delivery paradigm comprises delivering MPEG-based video content, with the video transported to user PCs (or IP-based STBs) over the aforementioned DOCSIS channels comprising MPEG (or other video codec such as H.264 or AVC) over IP over MPEG transport stream (MPEG-TS). That is, the higher layer MPEG- or other encoded content is encapsulated using an IP protocol, which then utilizes an MPEG packetization of the type well known in the art for delivery over the RF channels, such as via a multiplexed transport stream (MPTS). In this fashion, a parallel delivery mode to the normal broadcast delivery exists; i.e., delivery of video content both over traditional downstream QAMs to the tuner of the user's STB or other receiver device for viewing on the television, and also as packetized IP data over the DOCSIS QAMs to the user's PC or other IP-enabled device via the user's cable modem. Delivery in such packetized modes may be unicast, multicast, or broadcast. Delivery of the IP-encapsulated data may also occur over the non-DOCSIS QAMs, such as described below with respect to FIG. 1c.

The CPE 106 are each configured to monitor the particular assigned RF channel (such as via a port or socket ID/address, transport stream ID, or other such mechanism) for IP packets intended for the subscriber premises/address that they serve.

While the foregoing network architectures described herein can (and in fact do) carry packetized content (e.g., IP over MPEG for high-speed data or Internet TV, MPEG2 packet content over QAM for MPTS, etc.), they are often not optimized for such delivery. Hence, in accordance with another embodiment of the present disclosure, a “packet optimized” delivery network is used for carriage of the packet content (e.g., IPTV content). FIG. 1c illustrates one exemplary implementation of such a network, in the context of an IMS (IP Multimedia Subsystem) network with common control plane and service delivery platform (SDP), as described in co-owned, co-pending U.S. patent application Ser. No. 12/764,746 filed on Apr. 21, 2010 and entitled “METHODS AND APPARATUS FOR PACKETIZED CONTENT DELIVERY OVER A CONTENT DELIVERY NETWORK”, which is incorporated herein by reference in its entirety. Such a network provides significant enhancements in terms of common control of different services, implementation and management of content delivery sessions according to unicast or multicast models, quality-of-service (QoS) for IP-packetized content streams, etc.; however, it is appreciated that the various features of the present disclosure are in no way limited to any of the foregoing architectures.

### Data Transfer Network Architecture—

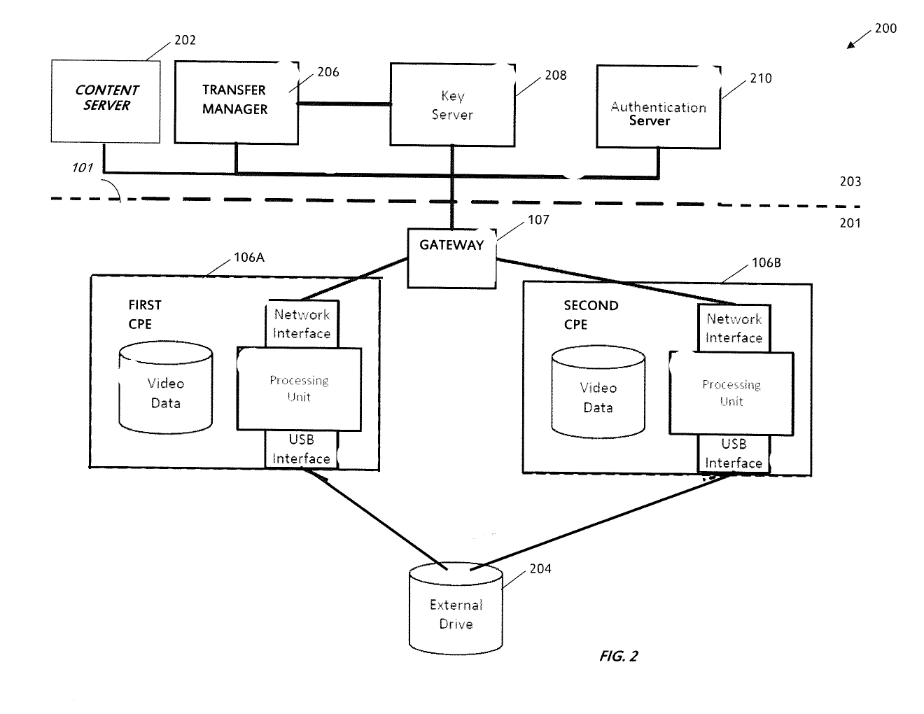

FIG. 2 is a block diagram illustrating a data (e.g., content) distribution network architecture 200 configured in accordance with one embodiment of the present disclosure. As illustrated, the network 200 generally comprises a headend portion 203 and a user premises portion 201.

A content server 202 at the network headend 203 is configured to provide requested content/data to one or more consumer premises equipment (CPE) 106 in communication with the content server 202 via the network 101. In one embodiment, the network 101 comprises a managed (e.g., MSO-controlled) delivery network, such as e.g., a content distribution network of the type discussed above with respect to FIGS. 1-1c. Content may be provided directly from the content server 202 to the consumer premises equipment (CPE) 106 (including the first CPE 106A and/or second CPE 106B), or may be provided to an intermediary device, such as a gateway 107. Other configurations may also be used consistent with the present disclosure.

In the instance that content is provided to the client devices 106 from the network via a gateway 107, it is appreciated that in one variant, the gateway 107 may be of the type discussed in co-owned, co-pending U.S. patent application Ser. No. 12/582,619 filed on Oct. 20, 2009, published as U.S. Patent Application Publication No. 2011/0093900 and entitled “GATEWAY APPARATUS AND METHODS FOR DIGITAL CONTENT DELIVERY IN A NETWORK”, which is incorporated herein by reference in its entirety. As discussed therein, internet (or IP packetized) content is received from the network 101, de-encapsulated from a first media file container format, and subsequently re-encapsulated to a second media file container format which is compatible with one or more receiving devices (such as CPE 106). For example, content which is delivered from a host server (such as the content server 202) may be encapsulated in e.g., MP4, if the receiving client device(s) are not capable of reading the MP4 files, the gateway may re-encapsulate to e.g., MPEG-2 or other format that the receiving device is capable of reading. The gateway 107 may process received content automatically into various alternative encapsulation formats or, may encapsulate as needed to the format of the specific requesting device. The processed content may also be stored at the gateway 107 or other data storage (whether at the premises or network) for future use for transmission to other client devices requesting the same content in the particular new format. In this manner, the gateway 107 may leverage a delivery of requested content in IP format to services requests from legacy devices for non-IP content, including a shifted delivery of the IP format content.

In another alternative, the gateway 107 may merely act as a proxy for the CPE 106 to submit requests for content and receive the requested content on its behalf.

In yet another embodiment, the gateway 107 (and/or one or more of the first CPE 106a or second CPE 106b; collectively referred to herein as “CPE 106”) provides the capability to transmit content (such as from one CPE 106 to another) and/or deliver content (such as from the gateway 107 to one or more CPE 106) in a plurality of video formats of various resolutions and bitrates including, without limitation, MPEG-1, MPEG-2, MPEG-4, AVC/H.264, WMV, VC-1, AVI and Real. The device (e.g., gateway 107 and/or CPE 106) also is capable of transmitting/delivering a plurality of audio formats or codec including e.g., MPEG-2 Audio, AC-3, AC-3+, AAC+, MP3, Real and WMA. A plurality of photo or image formats are also supported, including e.g., Graphic Image File (GIF), Joint Photographic Experts Group (JPEG), Bitmap (BMP) and Tag Image File Format (TIFF).

In a further variant, the gateway 107 and/or CPE 106 is not required to contain a decoder for decoding audio/video/media; however, it will be recognized that such decoder capability (as well as transcoding, e.g. decoding in a first format and then encoding in a second format) and/or transrating capability (i.e., processing so as to change bitrate, or establish a constant bitrate output) can be implemented to facilitate either content delivery or content transfer if desired.

In another exemplary embodiment, the gateway 107 and/or CPE 106 are compliant with OpenCable™ Home Networking architecture as disclosed in OpenCable™ Specifications Home Networking 2.0 (OC-SP-HNP2.0-110-130530 dated May 30, 2013), which is incorporated herein by reference in its entirety. As discussed therein, a compliant device includes, inter alia, compatibility with the Digital Living Network Alliance (DLNA) requirements such as DLNA version 1.0 or the later version thereof. This capability allows, among other things, rendering of content in DLNA 1.5 format, and generating a content directory using DLNA. As will be discussed in greater detail below, the foregoing functionality may be useful in, for example, providing a list of content available for transfer from the first CPE 106a to the second CPE 106b and/or for delivery from the gateway 107 to the CPE 106.

In yet another embodiment, the gateway 107 (and/or one or more CPE 106) of FIG. 2 may comprise a media bridge apparatus of the type discussed in co-owned, co-pending U.S. patent application Ser. No. 12/480,597 filed on Jun. 8, 2008 and published as U.S. Patent Application Publication No. 2010/0313225 entitled “MEDIA BRIDGE APPARATUS AND METHODS”, which is incorporated herein by reference in its entirety. As discussed therein, content and data are transmitted to various devices for use and viewing thereon via a media bridge. The bridging apparatus may be used, for example, to convert content stored on a PMD to a format capable of being presented on a user's set-top box or other client device, and vice versa. Control of the presentation is also provided by the bridging apparatus. In one embodiment, the apparatus enables a user to access and control playback of media from a PMD via a user interface associated with a television, personal computer or other user device. The apparatus may also enable content stored on the PMD to be copied and stored on a user's digital video recorder (DVR) or other storage apparatus, and to allow the premises user devices to share media content with the PMD consistent with the present disclosure, while maintaining appropriate copyright and digital rights management (DRM) requirements associated with the content being manipulated.

As illustrated, the gateway 107, first CPE 106a, and second CPE 106b physically and logically interface with one another via the illustrated network interfaces. The present disclosure also contemplates the use of different types of physical/logical interfaces, including a substantially universal or converged interface (such as USB 2.0, USB 3.0, IEEE-1394, DisplayPort, Thunderbolt, etc.), or alternatively, a plurality of discrete interfaces. In yet another variant, the CPE 106 utilizes a Universal Plug and Play (UPnP) AV media server to allow content such as music, videos and photos to be delivered to UPnP media rendering/recording devices (CPE 106, client 107, etc.). Universal Plug and Play (UPnP) AV media server requirements are described in detail in, inter alia, MediaServer:3 Device Template Version 1.01, dated Sep. 30, 2008 which is incorporated herein by reference in its entirety; see also “UPnP™ Device Architecture” Version 1.1, dated Oct. 15, 2008, which is also incorporated herein by reference in its entirety.

The first CPE 106a of FIG. 2 is configured to communicate with various other devices including e.g., the other CPE 106b, personal media devices (PMD), laptop computers, tablets, etc. in order to provide access to the requested content/data thereto. It will be appreciated that the term “client” in the context of the present disclosure in no way mandates a client-server or master-slave relationship; in fact, a “client device” may act as a local content server or source, as described in greater detail subsequently herein. Moreover the term “client premises device” is in no way intended to exclude mobile devices and/or devices not located within a premises.

In one variant, the first CPE 106a and/or second CPE 106b are in communication with a separate storage device (external drive 204) having a capability to store media files (such as to removable optical disks). For example, so-called “CompactFlash™”, a flash-based USB key or external hard drive, solid state storage device, secure digital card (e.g., SD Card), or the like, may be utilized, the CPE 106 being configured to receive the portable storage device (such as by having the appropriate port). In one embodiment, the external drive 204 is in communication with the CPE 106 via a USB interface; however, another wired or wireless communication protocol may be utilized with equal success. The external drive 204 may store the content recorded by the first client device 106a to which the second client device 106b is to be given access. Alternatively, the external drive 204 may serve as temporary or ephemeral storage for the content during a re-encryption process discussed elsewhere herein.

The exemplary first CPE 106a and/or second CPE 106b may comprise, without limitation, a set top box (STB), a digital video recorder (DVR), PCs, laptop computers, portable music players (e.g., MP3 players, iPod™, etc.), portable video players, cameras, video recorders, smart phones, etc., which are coupled via any number of different interfaces.

Communication between the first CPE 106a and the second CPE 106b may be wired (e.g., CAT-5, MoCA, etc.), or be conducted over WLAN (e.g., Wi-Fi), PAN, or other wireless communications protocol. For instance, a “premises LAN” may be created (e.g., at the premises network 201), which may include for example the network formed over the installed coaxial cabling in the premises, a Wi-Fi network, and so forth.

In order to facilitate the content transfer, it is appreciated that in one embodiment, the user pre-configures which device is the first device 106a (from which content is to be removed) and which device is the second device 106b (to which content is to be provided). In this manner, the user may be able to add additional devices to the premises network 201 without accidentally moving all content in the network to that device. This may be accomplished using e.g., the IP or MAC address of each device via a user interface.

Although content delivered and/or transferred to the various devices in the present disclosure (e.g., CPE 106) may optionally comprise personal or other media content which does not require rights management (e.g., Digital Rights Management (DRM)) or copy-protection, the present disclosure additionally provides mechanisms for the secure transfer of this and other content between devices as discussed herein. Note also that notwithstanding a lack of rights management required, the user none-the-less may desire to maintain the privacy of the content.

Specifically, as discussed herein, “protected” content is delivered in one embodiment to the CPE 106 (such as via the content server 202, gateway 107, and/or other CPE 106) with an appropriate security applied thereto. In one embodiment, the security applied comprises encryption of the content with a content key that is specific to the first CPE 106a. In one variant, authentication (such as for example by previous registration of each of the devices to the content server 202 authentication server 201, and/or gateway 107) may be required prior to the delivery of protected content thereto. Pre-registration puts the device in the billing system as well as some type of identifier—a digitally signed certificate, etc. that can be used to identify the device. In one implementation, when the device has been verified and the user account determined to be active the authentication server will pass a security token that can be used to access the content.

As noted elsewhere herein, in one implementation, the entirety of the content stored and/or associated with the first device 106a is transferred to the second device 106b (as opposed to copying all or part of it). This may occur for example when the first device 106a is being replaced with the second device 106b. Moreover, the content transfer as disclosed herein is performed wholly within the premises network 201 in one embodiment. Notwithstanding, it will be appreciated that some form of copying or replication may be used as part of the “movement” process. For instance, one exemplary scheme comprises first making a copy of the content present on the source device, saving the copy onto the target device, and then deleting the original rendering of the content on the source device, so as to inter alia provide safety against content loss due to electrical/mechanical, software, or other errors. Other techniques of such “ephemeral copying” may be used consistent with present disclosure as well.

In another variant, the rendering device is configured to authenticate the source of the content (i.e., will only render or record content from an authenticated source). For example, the apparatus and methods described in U.S. patent application Ser. No. 14/300,044 entitled “METHOD AND APPARATUS FOR NETWORK CONTENT DOWNLOAD AND RECORDING” and filed Jun. 9, 2014 and incorporated herein by reference in its entirety, can be used to provide such functionality, although other approaches may be used as well.

In order to ensure content transfer between the CPE 106 is authorized and enabled, a transfer manager 206 may be provided, such as at the network headend 203. In one embodiment, the transfer manager 206 m informed that content is to be transferred from the first CPE 106a to the second CPE 106b. Alternatively, the transfer manager 206 may merely be informed about the presence of other devices within a premises network 201. In response, the transfer manager 206 uses information about the subscriber associated to the first CPE 106a and information from the first CPE 106a itself to authenticate the transfer request via the authentication server 210.

Once the request is authenticated, the transfer manager 206 creates a shared encryption/decryption key to be used in the content transfer, which is placed on the key server 208. The shared encryption/decryption key is used by the first device 106a to format the content prior to transfer, and once content has been transferred to the second device 106b, second device 106b requests the shared encryption/decryption key from the transfer manager 206. In one variant, the transmission of the shared key to the first or second device 106 occurs via a secure socket layer (SSL). The transfer manager 206 authenticates the second device 106b (via the authentication server 210) prior to enabling the device 106b to access the key via SSL/SSH, or other. In one embodiment, the authentication of the request for the shared encryption/decryption key comprises utilization of information about the subscriber associated to the second CPE 106b and information from the second CPE 106b itself. Once the second device 106b obtains the shared key, it can be used to re-format the content with a key that is specific to the second device 106b (for secure storage thereon).

It is additionally noted that the content transfer may further comprise a transfer of metadata associated to the content. The metadata in one embodiment may be embedded within the data file. Alternatively, the metadata may comprise separate data file. In this instance, the metadata files for each content element to be transferred are additionally identified and transferred in a manner similar to that described herein with respect to the identification and transfer of content files.

Specific exemplary implementations of methods for content and data transfer between the first CPE 106a and the second CPE 106b of FIG. 2 are discussed below. It will be appreciated, however, that the following implementations are merely illustrative of the broader principles of the disclosure, and in no way limiting.

### Methodology—

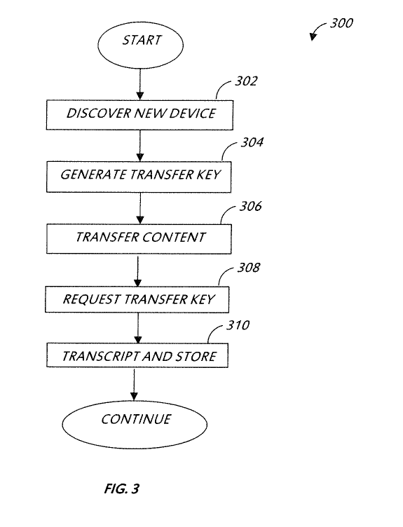

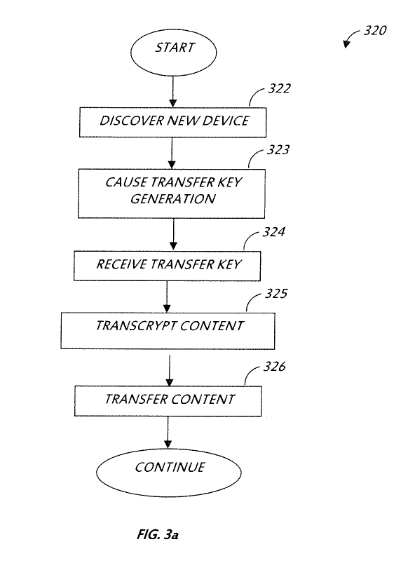

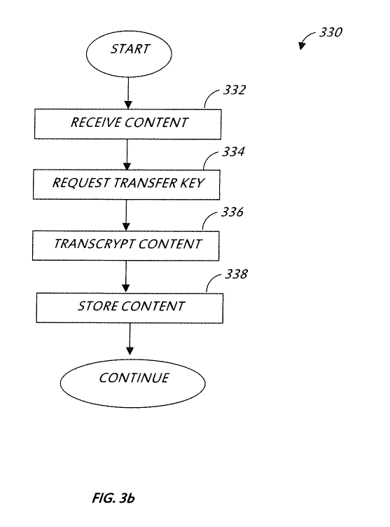

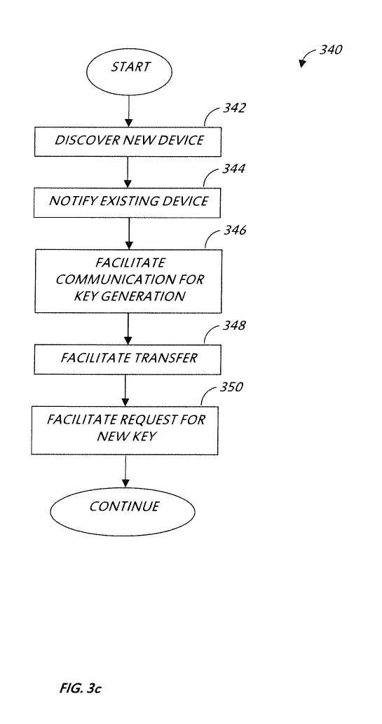

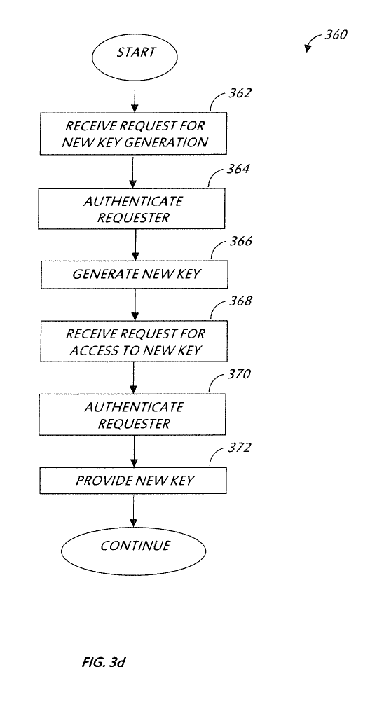

Referring now to FIG. 3, one embodiment of a method 300 for content and/or data transfer between a first CPE 106a and a second CPE 1 06b is illustrated.

As shown, per step 302, a new device is discovered. In one embodiment, the new device comprises a second or replacement CPE 106b that is automatically discovered by the gateway apparatus 107, such as when it is activated, connected (e.g., via wired or wireless interface), or powered on. Alternatively, the first CPE 106a may discover the second CPE 106b. In yet another embodiment, the second CPE 106b may identify itself to the transfer manager 206, gateway 107 and/or first CPE 106a.

In response to discovery of the new device, at step 304, a new encryption/decryption key is generated, referred to herein as a “shared key” or “transfer key”, or Kₛ. As discussed above, in one embodiment of the present disclosure, the content is specifically tied to the device on which it is stored. Hence, while it is stored at the first CPE 106a the content is encrypted using an encryption key which is specific to the first CPE 106a, referred to herein as the “original key” or Kₒ. The discovery of the second CPE 106b prompts a network entity (such as the transfer manager 206) to generate the transfer key in order to enable the content to be securely transferred to the second device 106b. In one variant, the foregoing may occur irrespective of any request to transfer the content to the second device 106b, rather the transfer manager 206 may pre-generate and pre-load the transfer key immediately, such as upon establishment of a premises network 201. According to this variant, the manager 206 is prepared in advance for requests to transfer content to any device within the premises network 201 prior to a specific request or need.

At step 306, a transfer of the content is completed. In one embodiment, the transferred content may comprise content which has been decrypted using the original encryption key (which is stored at and specific to the first device 106a), then re-encrypted using the transfer key obtained from the transfer manager 206. The transfer may comprise a decryption/re-encryption and transfer of the entirety of the stored content at a first CPE 106a to a replacement CPE 106b. Alternatively, as discussed in greater detail below, the transfer may comprise only certain ones of the content and/or may be spread across multiple devices (including e.g., an external storage apparatus 204). It is also appreciated that the first CPE 106a may be configured to store at least a portion of content in a separate (e.g., external) device such as the external drive 204 (either encrypted with the original key or the shared key). In the event the content has been transcrypted using the shared key, the content transfer therefore may occur directly from the external drive 204.

It is further noted that the content transfer may include an additional step for the transfer of metadata (not shown). That is, in the instance the metadata is not embedded within the content file, and instead comprises one or more separate files, the metadata files must also be transferred.

In another embodiment, the content is deleted from the first device 106a when it is transferred to the second device 106b. That is, a copy of the content is not kept at the first device 106b.

When the content transfer is complete, the device which receives the content requests the shared encryption/decryption or transfer key (step 308). In one alternative embodiment, the network entity which generates the key, Kₛ (such as the transfer manager 206 and/or key server 208) may automatically provide the key, Kₛ to the device upon its generation as opposed to waiting for a request therefor. In another embodiment, Kₛ is placed at the key server 208 and the second device 106b is directed to its location on the key server 208 when the device 106b requests the transfer key from the transfer manager 206.

Finally, per step 310, the replacement or second CPE 106b uses the transfer key to decrypt the content, then the device 106b re-encrypts the content using a device specific key stored thereon referred to herein as the “replacement key” or Kᵣ. The transcrypted content is then stored at the second device 106b or a storage entity associated therewith (such as storage entity 204).

In one variant, the content may be placed on a shared storage device (such as the external drive 204) by the first device 106a, then removed for transcryption (decrypted using Kₛ and re-encrypted using Kₛ), and replaced with the Kₛ transcrypted version. Then, the content may be accessed by the second device 106b, removed for transcryption (decrypted using Kₛ and re-encrypted using Kᵣ). In another variant, the storage device includes a secure transcription mechanism to decrypt/encrypt as discussed elsewhere herein. The Kᵣ transcrypted version then is stored at the shared device 204.

In another embodiment, the content is additionally processed prior to its transfer. In one variant, content processing may include re-encoding the content to another format or codec in preparation for its display by the second device 106b (or a display device in communication therewith). In another variant, the first device 106a may process the content into one or more compressed or alternative formats for subsequent transmission to mobile devices. These so-called “portable” versions of content are stored at e.g., the first 106a and/or the storage device 204 associated therewith.

FIGS. 3a-3d, illustrate exemplary methods of various features of the above-described content and/or data transfer; each of these will be discussed in further detail below.

Referring now to FIG. 3a, a logical flow diagram illustrating one embodiment of a method 320 for content transfer from a first device in accordance with one embodiment of the disclosure is illustrated. The method 320 is implemented by the first device 106a of FIG. 2.

As shown, per step 322, the first device 106a discovers the presence of a second device 106b in the premises network. In one embodiment, this may occur via a communication from a gateway device 107 (or other intermediary). Alternatively, the second device 106b may communicate its presence directly to the first CPE 106a.

In a still further embodiment, the first CPE 106a (or the gateway 107) may periodically (or according to another scheme) send a query to all devices within the premises network 201. When a response is received from a device from which previous responses have not been received, it is deduced that the device is newly entered into the network 201.

Next, per step 323, the first device 106a causes a shared key to be generated. This may occur for example via a message from the first device 106a to the transfer manager 206 indicating that a new device exists in the premises and/or indicating that the first device 106a intends to transfer some or all of its content to a second device 106b. The request to the transfer manager 206 to generate a transfer key is in one implementation accompanied by information identifying the device 106a and/or the subscriber to which the device 106a is associated. This information is used for authentication of the device 106a, as discussed elsewhere herein.

Instructions regarding how to access the shared key are then received at the first device 106a. That is, the manager 206 may provide the first device 106a with a location of the transfer key at e.g., the key server 208. Once Kₛ is retrieved (step 324) it is used to transcrypt the content (step 325). Specifically, the first device 106a uses an encryption key stored thereon and specific to the first device 106a, Kₒ, to decrypt content that is to be transferred. Next, the first device 106a uses the transfer key to re-encrypt the content. Finally, per step 326, the transcrypted content is transferred to the second device 106b. Alternatively, it may be placed on a shared external drive 204.

Referring now to FIG. 3b, one embodiment of a method 330 for content transfer to a second device is given. Per step 332, content is received either from the first device 106a directly or from a storage entity associated therewith (storage 204).

As noted above, prior to transfer thereof, the content of the exemplary embodiment is encrypted using the transfer key, Kₛ. In order to access the content, the second device 106b must obtain the transfer key from the network. Hence, per step 334, the second device requests the transfer key from the transfer manager 206. The key request to the transfer manager 206 may be accompanied by information identifying the device 106b and/or the subscriber to which the device 106b is associated. This information is used for authentication of the device 106b as discussed elsewhere herein.

In response to the request, the transfer manager 206 provides the second device 106b with information needed to retrieve Kₛ from the key server 208. It is noted that in an alternative embodiment, the transfer key may be immediately provided to every device within a premises network 201 without a specific request therefor (as discussed elsewhere herein); accordingly step 334 is optional. In one variant, this may require pre-registration or authentication of the second device 106b (and/or all devices in a premises network 201) to the transfer manager 206 and/or authentication server 210 in the absence of or prior to initiation of a transfer of content.

Once the key, Kₛ, is retrieved, it is used to transcrypt the content (step 336). Specifically, the second device 106b uses the transfer key to decrypt the content, then accesses a device specific encryption key, Kᵣ, (e.g., specific to the second device 106b and stored thereon) to re-encrypt the content. The re-encrypted content may then be stored (step 338) either at the device 106b or a storage entity in communication therewith (such as e.g., storage 204).

In the instance that a gateway device 107 is utilized for communication to/from the network 101 and/or between the devices 106, the method 340 of FIG. 3c may be utilized. As shown, per step 342, the gateway device 107 may in one variant be utilized to discover new devices within the premises network 201. The discovery may occur when a newly added device is powered on via either a request for data from the newly added device 106 to the gateway 107, or in the form of a response from the newly added device 106 to a query sent by the gateway 107.

When a new device 106 is discovered, the gateway 107 notifies the existing device 106 of its presence (step 344). In one embodiment, the gateway may first authenticate the newly added device 106 via communication of credentials from the device 106 and a comparison of the credentials either at the network 101 (such as via the authentication server 210) or to network provided information at the gateway 107. In addition, the gateway 107 may notify the transfer manager 206 of the presence of the new device 106b.

Next, per step 346, the gateway 107 facilitates communication between the existing device 106a and the transfer manager 206 for generation of a shared key. In one variant, the communication may include, e.g., the gateway 107 which acts as a proxy for the device 106a and which transmits a message on its behalf to the transfer manager 206 indicating that a transfer key should be generated.

The gateway 107 may also facilitate the content transfer at step 348. In one embodiment, this may include transmitting requests and delivery messages between the device as well as acting as an intermediary for storing the content.

Finally, at step 350, the gateway 107 facilitates the new key request. In one embodiment, this may include facilitating communication between the new device 106b and the transfer manager 206 to request access to the shared key. As noted elsewhere herein, in one embodiment the transfer key is automatically provided to new devices 106b as they enter the premises network 201, hence the foregoing step (step 350) may be optional.

Referring now to FIG. 3d, an exemplary embodiment of a method 360 for managing content transfer between two devices is illustrated. As shown, per step 362 a request for new key generation is received at the transfer manager 206. In one implementation, the request comprises at least information identifying the first device 106a from which the request is received. The transfer manager 206 uses information in the request to authenticate the device 106a and/or a user of the device 106a at step 364.

Authentication may occur at e.g., the authentication server 210, or another entity tasked with this process. Additionally, apparatus and methods for determining authentication may for example be of the type discussed in co-owned, co-pending U.S. patent application Ser. No. 12/536,724 filed Aug. 6, 2009 and entitled “SYSTEM AND METHOD FOR MANAGING ENTITLEMENTS TO DATA OVER A NETWORK”, which is incorporated herein by reference in its entirety. If the requesting device/user are not authenticated, transfer manager 206 does not further provide content and/or a content key thereto. In another variant, if the requesting device/user are not authenticated, an alert may be transmitted within the managed network 203 identifying the potentially suspicious activity.

Once the requesting device 106a and/or user of the device 106a are authenticated, a new key is generated (step 366). In one embodiment, the transfer manager 206 identifies the user or subscriber based on information contained in the key request (step 362). The transfer manager 206 then uses the information to create a content key which is to be uniquely assigned to the subscriber and shared among the devices associated to that subscriber, i.e., the shared key. The shared key is then placed on the key server and the transfer manager 206 notifies the requesting first device 106a that it may access the shared key. Additionally, the transfer manager 206 may provide the first device 106a (and/or the second device 106b as discussed elsewhere herein) with information necessary to access the key—that is, which port number to use, the IP address of the particular key server, etc. As discussed above with respect to the methods for content transfer (FIGS. 3a and 3b), the second device 106b receives content which has been encrypted using the shared encryption key. Accordingly, at step 368, a request for access to the shared key is received at the transfer manager 206.

In response to the request, the transfer manager 206 and/or authentication server 210 (in communication therewith) determines whether the requesting device is authorized to receive the requested content, and/or authenticates the requesting device (or a subscriber associated with the device), step 370. In one embodiment, apparatus and methods for determining authorization and/or authentication may be of the type discussed in co-owned, co-pending U.S. patent application Ser. No. 12/536,724 filed Aug. 6, 2009 and entitled “SYSTEM AND METHOD FOR MANAGING ENTITLEMENTS TO DATA OVER A NETWORK”, which is incorporated herein by reference in its entirety. If the requesting device/user is not authorized and/or authenticated, content cannot be provided thereto.

“Authentication” as used herein refers generally and without limitation to a determination that a device or user associated with the device (e.g., the requesting device) is among the devices which may receive content, and/or that a user of the requesting device is a subscriber to the network or other entitled user. This may be accomplished by requiring the user to log into the network (such as by password and/or user identification, challenge question, etc.) or by comparing some other unique identifier (such as MAC ID, digital signature, SIM ID) to a list of authenticated device identifiers at a headend entity (such as the aforementioned transfer manager 206). Other mechanisms may be used as well, and multiple such mechanisms can be used in parallel or sequence as desired.

“Authorization” as used herein refers generally and without limitation to the determination that the requested content is within the set or plurality of content the user (e.g., subscriber) or device may receive, and/or the proposed use of the content is within the allowed use set for that subscriber. For example, authorization may be used to refer to whether the requested content is within the subscription plan (e.g., level or tier) for the requesting user. Other security or rights-related checks may be performed at this step as well.

Finally, once the device and/or user is/are authenticated, the newly generated transfer key (or shared key) is provided to the requesting device 106b. In one embodiment, this occurs via a series of communications between the transfer manager 206 which authenticates the device and/or user, and the key server 208 which stores the shared key and provides the key to the requesting device 106b.

### Usage/Copy Rules—

In another variant, the foregoing methods of FIGS. 3-3d may further include determination and delivery of a set of usage/copy rules for the requested content. The usage/copy rules may comprise for instance metadata stored along with the requested content, may be transmitted separately (e.g., via an encrypted file), or may be manually entered. In one embodiment, the usage/copy rules comprise Digital Transmission Content Protection-Internet Protocol (DTCP-IP) rules indicating (i) whether content may be copied (e.g., “copy never”), (ii) how many times the content may be copied (e.g., “copy once”, “copy freely”, etc.). Additionally, these usage/copy rules may comprise extended usage requirements including e.g.: (1) a length of time or expiration for the content, (2) a rule for automatically causing deletion of the content after play-out (or a number of play-outs), (3) disablement of various functions (e.g., “trick modes”), and/or (4) limitations on the number of play-outs of moved content (e.g., N play-outs within X period of time). Any or all of the aforementioned usage rules may be further limited based on e.g., the class or type of devices which may copy the content, the type of content, the subscription level of the subscriber associated with the devices, etc. Additional usage/copy rules may also be provided either when the content is transferred from the first device 106a to the second device 106b or from the network (such as from the transfer manager 206).

In one variant, a first set of usage/copy rules may be received from the content source (or other network entity). These rules may include more traditional usage/copy rules such as the aforementioned “copy never”, “copy once”, “copy freely”, etc., or other types of restrictions. The usage/copy rules are received at the content server, and associated with content. The content is then requested by a first user and transmitted to the first user device 106a. The aforementioned rules are provided to the requesting device alongside a second set of usage/copy rules which are specific to the first device 106a and/or subscriber. For example, the transfer manager 206 or other network entity may, when a request for content is received, query a billing entity (or other network entity) to determine one or more additional rules sets to be applied to the subscriber. The same occurs when a request to transfer content is received (as triggered by a key generation request) from the second device 106b. Assuming, for example, the requesting subscriber is a lower tier subscriber with only rights to maintain a transmit a copy from a first device to a second device for a prescribed period of time, the content server 201 establishes these restrictions as a second set of usage/copy rules. A rules package including the traditional (e.g., DTCP-IP) rules, as well as the subscriber-specific rules, may be provided to the subscriber with the content. It will be appreciated that the second set of rules may alternatively or concurrently be specific to the requesting device, other devices within a subscriber's premises (which may or may not be under MSO control), and/or may be still further related to the requested content itself (such as “premium” content).

In yet another variant, the foregoing methods of FIGS. 3-3d and network apparatus of FIG. 2 may be further utilized to generate a list of available content for transfer. In other words, the first device 106a is configured to generate a list or directory of content which is available for transmission to one or more second devices 106b. The determination of which content is available for transmission to second devices 106b may be based on the aforementioned usage/copy rules. The list is derived at a processor of the first CPE 106. Alternatively, the available content list may be generated at another entity, such as the aforementioned gateway apparatus 107 or transfer manager 206. The available content list may further take into account the capabilities of the second client device(s) 106b. For example, when a particular second client device 106b is only capable of decoding content in a specific format, the list may only include those items which were present at the first client 106a in the given format. Alternatively the gateway apparatus 107 or other network 203 entity may be utilized to transcode all the content present at the first device 106a for transmission to the second device 106b.

It will also be appreciated that while the method of FIGS. 3-3d described above utilize a “request/response” model, the foregoing methods may also be configured to operate using a “content push” model, whereby the first device 106a initiates a transfer of the content without receiving a request for it from the second device 106b. This might occur via a command entered at the first device 106a or may occur automatically when a second device 106b enters the premises network 201.

### Consumer Device—

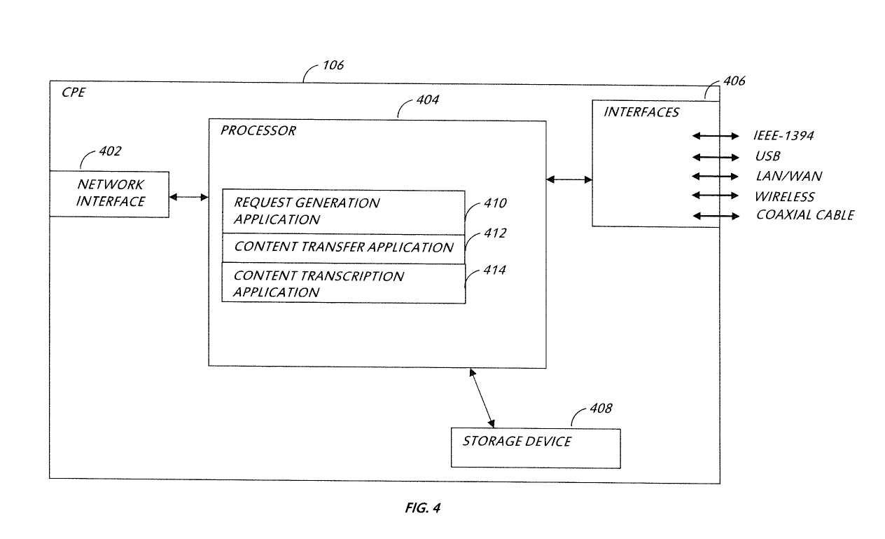

FIG. 4 is a block diagram illustrating an exemplary user device for use in the present disclosure. The illustrated consumer premises equipment (CPE) 106 is intended to represent both the first devices 106a and second devices 106b, as it is appreciated that these device may have similar components and functionality.

The CPE 106 may comprise any device capable of receiving and decoding content, including IP packetized content, whether for display thereon, or for recording, display, or storage on a device in communication therewith. Exemplary devices include set-top boxes, IP-enabled television sets, laptop and desktop computers, and even cellular smartphones, personal media devices (PMD), etc. In one exemplary embodiment, the CPE 106 is compatible with Digital Living Network Alliance (DLNA) standards for consumer electronics (such as those discussed in DLNA Interoperability Guidelines, version 1.5, published March 2006 (expanded October 2006), which is incorporated herein by reference in its entirety) for signaling purposes, and also makes use of a digital rights management (DRM) content protection scheme to comply with limitations on certain content, or provide authorization credentials with respect to protected content.

As illustrated, the exemplary CPE 106 of FIG. 4 includes a first interface 402 for communication with a network. The CPE 106 may communicate with entities of the content delivery network 101 and/or network 203. The CPE 106 requests and receives content via this interface 402. In addition, the CPE 106 requests and receives the transfer key via the network interface 402. The CPE 106 further comprises a digital processor 404, a storage device 408, and a plurality of back-end interfaces 406 for communication to a plurality of additional subscriber devices (e.g., other CPE 106, gateway 107, external drive 204, etc.).

The storage device 408 of the CPE 106 may be configured to store a plurality of available content thereon, including the same content in various formats (e.g., a mobile or compressed format). Alternatively the content may be stored at the external drive 204. The storage device 408 further store one or more computer applications which are run on the aforementioned processor 404. The storage device 408 may comprise, for example, a random access memory (RAM), a hard disk drive, an optical drive (e.g., CD-ROM or DVD), NAND flash memory, or some combination thereof.

The processor 404 is configured to run at least a request generation application 410, a content transfer application 412, and a content transcryption application 414 thereon. The foregoing applications may be provided to the CPE 106 prior to installation and/or downloaded over the network 101. The request generation application 410 is configured to generate a request for a shared key. In one embodiment, where the CPE comprises the first device 106a, the request generation application 410 receives information that a new device (second device 106b) has entered the premises 201 and uses this information to begin generating a request. Alternatively, the request generation application 410 may be manually triggered to begin a request (such as via a user's manual input at a GUI). The request generated by the request generation application 410 includes information identifying the device 106 and/or the subscriber and any other information necessary for authentication/authorization via the network 203; and requests that the transfer manager 206 generate a transfer key. Once the key is generated, and the device 106 is informed of its location, the request generation application 410 may be used to request access to the newly generated shared key. In the instance the CPE 106 is the second device 106b, the request generation application 410 is simply used to request access to the shared key.

The content transfer application 412 is configured to identify content which may be transferred to another device. The content transfer application 412 further facilitates the physical transfer of the content to the second device 106b and/or from the first device 106a. In addition, in the instance, the content is stored at the external drive 204, the content transfer application 412 facilitates delivery of the content from the external drive 204 to the new device 106b and/or to another external storage device (if necessary).

The content transcryption application 414 is configured to enable the device 106 decrypt and re-encrypt content. In the embodiment where the device comprises a first device 106a, the transcryption application 414 enables the device to, once the shared key, Kₛ, is obtained via the request generation application 410, decrypt the content using its original key or Kₒ, then re-encrypt the content using the shared key. After the transcryption, the content transfer application 412 facilitates transfer of the content. In the embodiment where the device comprises a second device 106b, the transcryption application 414 enables the device to, once the content is received from the first device 106a and the shared key is received via the request generation application 410, decrypt the content using the shared key, then re-encrypt the content using the device specific key (referred to herein as the replacement key, Kᵣ).

The CPE 106 further comprises a plurality of back-end interfaces 406 for communication to a plurality of additional subscriber devices (e.g., other CPE 106, client 107, etc.). As illustrated, the CPE 106 may communicate via any number of available technologies. Suitable interfaces include for example USB, Wi-Fi, FireWire (IEEE 1394), MoCA, Bluetooth, IEEE 802.3, HDMI, DisplayPort, or any number of other adapted for digital data transfer and signaling.

It will also be further recognized that the particular CPE 106 configuration shown in FIG. 4 is for illustrative purposes, and various other configurations of the CPE 106 are consistent with the disclosure. For example, the CPE 106 may not include all of the elements shown in FIG. 4, and/or may include additional elements and interfaces such as for example an interface for the HomePlug AIV standard which transmits digital data over power lines, specialized networking, optical audio interface, or security processors, a PAN (e.g., 802.15), Bluetooth, or other short-range wireless interface for localized data communication, a longer range WLAN or Wi-MAX (IEEE Std. 802.16) interface, etc.

In another embodiment, the CPE 106 includes a display or other user interface element capable of displaying one or more indications, such as LEDs. LCDs, monitors, etc. A “soft” display (e.g., TFT or LCD display having software generated indications) may be used on the CPE 106 (or a remote device in communication therewith, such as a wireless remote control) to provide a flexible display environment. Moreover, the methods and apparatus of co-owned and co-pending U.S. patent application Ser. No. 10/773,664 filed Feb. 6, 2004 entitled “METHODS AND APPARATUS FOR DISPLAY ELEMENT MANAGEMENT IN AN INFORMATION NETWORK”, incorporated herein by reference in its entirety, may be used within the CPE 106 or other communicating devices (e.g., client 107). Specifically, display elements such as GUI windows or discrete indicators in a client device running multiple related or unrelated applications can be managed and controlled. In one embodiment, an improved window management entity is provided within the device with which HAVi-compliant application(s) can interface in order to access display elements according to a priority structure or hierarchy. One or more privileged applications are designated and allowed to affect the priority structure, including requesting a new in-focus application to be placed atop the priority structure. The network operator can also optionally control the operation of the window manager remotely via a network agent.

The CPE 106 may also include a MoCA-compliant IC or chipset, with or without discrete components, so as to facilitate networking of content (such as HD content) over coaxial cabling within the premises, as described in greater detail elsewhere herein.

The CPE 106 may further provide a mechanism to identify new CPE 106 on the network, and grant or deny content thereto based on, e.g. conditional access privileges or business rules.

In another embodiment, the CPE 106 has associated therewith a display apparatus for the display of content, and/or a DVR or other recording and/or storage apparatus (external drive 204) which can be used to backup or store content, media, or data files.

### Gateway Device—

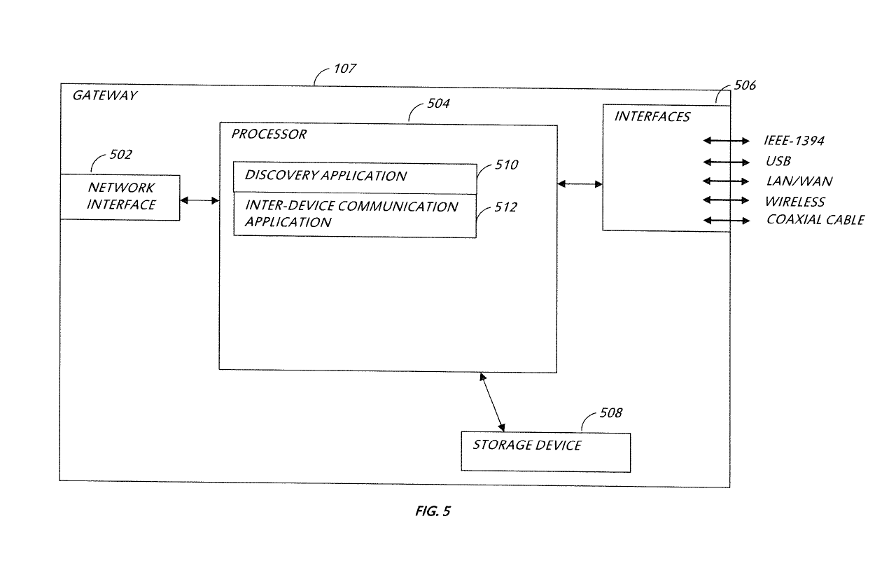

Referring now to FIG. 5, one exemplary embodiment of the gateway device 107 is illustrated. As shown, the gateway device 107 comprises a network interface 502, processor 504, mass storage 508, and backend interfaces 506.

The network interface 602 in one embodiment comprises a cable modern, such as e.g., a DOCSIS 3.0 compliant cable modem of the type discussed in “DOCSIS® 3.0 Management Features Differences Technical Report” CM-TR-MGMTv3.0-DIFF-V01-071228 and “DOCSIS 3.0 OSS1 Configuration Management Technical Report” CM-TR-OSSIv3.0-CM-V01-080926, each of which is incorporated herein by reference in its entirety. The cable modem provides DOCSIS connectivity to the CPE 106 to be used for network communication (such as communication with the transfer manager 206, key server 208, authentication server 210, etc.) as previously described), as well as various other purposes (such as VOD, Internet “surfing”, interactive program guide (IPG) operation, etc.). In an alternative embodiment, the CPE 106 may communicate directly with the headend or other entities.

The network interface 502 of the gateway device 107 further comprises one or more QAM tuners configured to receive content from the HFC network 101. The RF tuner(s) may comprise traditional video RF tuner(s) adapted to receive video signals over, e.g., a QAM. For example, the RF tuner(s) may comprise one or more tuners, a demodulator, decryption module, and demultiplexer of the type well known in the art, although other configurations may be used. The number and type of QAM tuners utilized in the gateway device 107, as noted above, may be varied so as to ensure tuning across the entire available spectrum. Alternatively, different classes of devices may be provided each class having a different tuning range capability. In another variant, the CPE 106 may comprise its own QAM tuners for the receipt of content.

The gateway 107 may further include a wide band tuner, such as that discussed in previously referenced co-owned, co-pending U.S. Patent Application Publication No. 20060130113 entitled “METHOD AND APPARATUS FOR WIDEBAND DISTRIBUTION OF CONTENT” and filed Dec. 14, 2010. The wideband tuner arrangement enables the gateway 202 to receive content associated with one or more program streams distributed across two or more QAMs. Additionally, the RF tuner(s) may incorporate functionality to modulate, encrypt/multiplex as required, and transmit digital information for receipt by upstream entities such as the CMTS. The tuners may additionally be capable of tuning across the entire band of QAM channels.

The gateway device 107 can assume literally any discrete form factor, including those adapted for settop/desktop, hand-held, or wall-mounted use, or alternatively may be integrated in whole or part (e.g., on a common functional basis) with other devices (such as the CPE 106) if desired. Additionally, the gateway device 107 may include other elements and interfaces such as for example an interface for the HomePlug A/V standard which transmits digital data over power lines, WiFi capability, a PAN (e.g., 802.15), Bluetooth, or other short-range wireless interface for localized data communication, etc.

The gateway 107 processor 504 is configured to run a discovery application 510 and an inter-device communication application 512 thereon. The foregoing applications may be provided to the gateway 107 prior to installation and/or downloaded over the network 101. The discovery application 510 enables the gateway 107 to identify when new devices 106 have entered a premises network 107. Additionally, the discovery application 510 may notify the transfer manager 206 and/or other premise devices of the newly discovered devices 106.

The inter-device communication application 512 facilitates communication between the first device 106a, second device 106b, transfer manager 206, key server 20S, and authentication server 210 in one embodiment. That is, in the instances these entities do not communicate directly, the inter-device communication application 512 enables the gateway 107 to act as a proxy for the communication therebetween.

Communication between the gateway 107 and the client devices 106 occurs via the backend interfaces 506. As noted previously, such communication may utilize e.g., IEEE 1394, USB, LAN/WAN, wireless, and/or MOCA communications protocol with equal success.

Still further, the gateway 107 may provide IP content to legacy (i.e., non-IP capable) devices (such as CPE 106). For example, in one embodiment, the gateway apparatus 202 may be of the type discussed in co-owned, co-pending U.S. Patent Application Publication No. 2011/0093900 filed on Oct. 20, 2009 and entitled “GATEWAY APPARATUS AND METHODS FOR DIGITAL CONTENT DELIVERY IN A NETWORK”, which is incorporated herein by reference in its entirety. As discussed therein, internet (or IP packetized) content is de-encapsulated from a first media file container format and subsequently re-encapsulating to a second media file container format which is compatible with one or more receiving devices. For example, content which is delivered from a host server may be encapsulated in e.g., MP4. If the receiving client device(s) are not capable of reading the MP4 files, the gateway device 107 may re-encapsulate to e.g., MPEG-2 or other format that the receiving device is capable of reading. The gateway device 107 may process received content automatically into various alternative encapsulation formats or, may encapsulate as needed to the format of the specific requesting device. The processed content may also be stored at the gateway 107 or other data storage (whether at the premises or network) for future use for transmission to other client devices requesting the same content in the particular new format.

### Transfer Manager—

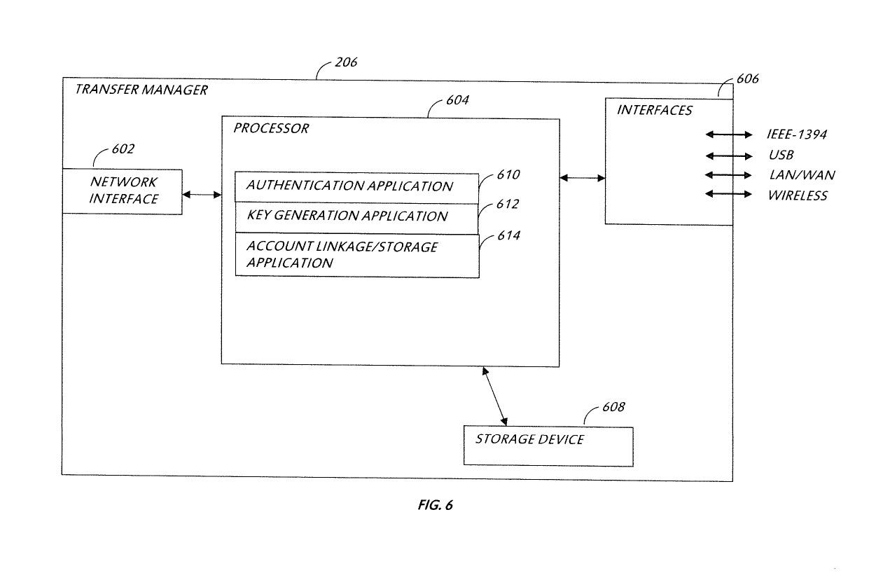

FIG. 6 illustrates one exemplary embodiment of a transfer manager 206 useful with the present disclosure. As shown, the transfer manager 206 generally comprises a network interface 602 for interfacing with other entities of the content delivery network 101 and/or the managed network headend 203, a processor 604, a storage apparatus 608 and a plurality of interfaces 606 for communication with e.g., the CPE 106, gateway 107, or other network (MSO network 101, headend 203, and/or non-MSO network) entities.

As discussed above, the other entities with which the transfer manager 206 may be in communication, as well as the transfer manager 206 itself, may be located at a network headend 150 and/or network headend 203 (see FIG. 2), another portion of the MSO network 101, or alternatively at a non-MSO network. Accordingly, the network interface 602 and/or interfaces 606 may be utilized for communication therewith.

The processor 604 is configured to run at least an authentication application 610, a key generation application 612, and an account linkage/storage application 614 thereon. The authentication application 610 is configured to authenticate a requesting device 106. Specifically, when a request to have a shared key generated and/or access a shared key is received, the authentication application 610 determines (based on information stored in the request) whether the subscriber and/or device is authenticated prior to enabling the key generation and/or access. In another embodiment, the authentication occurs at the authentication server 210.

The key generation application 612 generates a shared key, Kₛ, as discussed herein. The key generation application 612 links a particular shared key to a subscriber account and stores records regarding the linkage via the account linkage/storage application 614. The key itself, once generated is then stored at the key server 208. As noted previously, the key may be generated upon the introduction of new devices to the premises 201 and/or upon a specific request therefor. In addition, it is appreciated that in one embodiment the key generation process is performed at the key server 208.

### Premises Networking—

In yet another embodiment, the gateway 107 and/or CPE 106 may also create a premises network 201 (such as a Local Area Network (LAN) utilizing the existing coaxial cable or CAT-5 cable in a home) for communication between the various devices associated with a subscriber. For example, an Ethernet-over-coax based technology allows services to be delivered to other devices in the home utilizing a frequency outside (e.g., above) the traditional cable service delivery frequencies. See also the MoCA (Multimedia over Coax) alliance and MoCA Standard Versions 1.0 and 1.1, which are incorporated herein by reference in their entirety, which describe OFDM-modulated radio frequency signals on the order of 1 GHz delivered over extant coaxial cable systems. Accordingly, one embodiment of the disclosure uses frequencies on the order of 1150 MHz to deliver content and data to other devices in the home such as PCs, laptop computers, other PMD, media extenders, and set-top boxes. The coaxial network is merely the PHY or bearer; devices on the network utilize Ethernet or other comparable networking protocols over this bearer to effectuate local area networking.

In one embodiment, the home network is established according to the OpenCable™ Application Platform (OCAP) Specification: OCAP Home Networking Extension protocol (OC-SP-OCAP-HNEXT-103-080418, dated Apr. 18, 2008), incorporated herein by reference in its entirety. As disclosed therein, content may be shared among a plurality of networked CPE 106, described herein. Accordingly, content may be shared among all the CPE 106 via an Ethernet-over-coax topology, or another interface of the various CPE 106 and/or the gateway 107.

As noted previously, content from the CPE 106 may be stored on an internal mass storage device thereof and/or another connected device (e.g., RAID, DVR, etc.) thereto (e.g., external drive 204), or may be transmitted directly from storage to the requesting or target device. In one embodiment, content is securely delivered to any viewing location in the premises network 201 that shares a common security model via the various PHY interfaces available, including e.g., Wi-Fi, USB, 1394, and Ethernet.

In yet another embodiment, the CPE 106 and/or gateway 107 may utilize UPnP A/V to access the content listed in other CPE 106 directories.

In one embodiment, the CPE 106 and/or gateway 107 can automatically discover all DLNA-capable clients (e.g., other CPE 106, etc.) during boot up or other events, and present the available content from the CPE 106 content directory (DLNA CDS) to them. The CPE 106 may also be adapted to automatically start a DLNA-compatible media server (which has a UPnP Content Directory Service) at boot using only the aforementioned Ethernet, MoCA and/or Wi-Fi network interfaces. The CPE 106 reads the content directory from the media device (such as e.g., reading all the content over the Accessory Serial Protocol), and builds a local database of that content. The CPE 106 then publishes the content to its digital media server, in order for any digital media player to see the content. Once specific content is selected by a media player for playback, the CPE 106 utilizes the aforementioned methods to deliver the content thereto.

### Trusted Domain—

It will further be recognized that the present disclosure can be used in conjunction with a so-called “trusted domain” for content and other data protection if desired. Exemplary trusted domain apparatus (and methods) are described in co-owned and co-pending U.S. patent application Ser. No. 11/006,404 filed Dec. 7, 2004 and entitled “TECHNIQUE FOR SECURELY COMMUNICATING PROGRAMMING CONTENT”, as well as U.S. patent application Ser. No. 10/894,884 filed on Jul. 20, 2004 of the same title, each of the foregoing being incorporated herein by reference in its entirety, although other approaches may be used consistent with the present disclosure. These applications disclose, inter alia, a multi-layered rights arrangement to prevent unauthorized use and transfer of protected content, especially in a premises network 201. For example, the network may be considered to comprise multiple layers. One such layer may be a “trusted domain,” described in aforementioned U.S. application Ser. No. 10/894,884. For example, in a managed network system, the trusted domain might include not only the system portion where programming content traditionally is secured by (and within total control of) a network operator, including, e.g., the headend, delivery network, etc., but also user devices, e.g., DSTBs, or other CPE 106, at subscribers' premises which are capable of receiving and securely storing programming content in a prescribed manner. The network operator can control certain subscriber access and usage with respect to content held within the trusted domain. For example, movie content held within a network operator's trusted domain (e.g., on a hard drive of an STB or CPE) cannot be distributed over the Internet in viewable form, and cannot become a source for duplication of multiple viewable copies.

A second layer of the network may be defined as being outside the trusted domain. A device in the second layer is assigned an indicator indicating an extent of security of the device. For example, when the device in the second layer requests transfer of protected content from a device in the first layer, the first layer device authenticates the second layer device to determine legitimacy of the device for receiving the protected content. After the second layer device is authenticated, the first layer device transfers not only the protected content, but also a set of rules associated with the protected content as previously described. At least some of the rules in the set are associated with the indicator and applicable to the second layer device with respect to use of the protected content.

The foregoing disclosures broadly encompass the concept of the multi-layered rights arrangement including the trusted domain for preventing unauthorized use of protected content. It will therefore be appreciated that the present disclosure is not limited to use of specific devices in the arrangement. For example, the disclosure may also apply to a host device connected to a CableCARD module, jointly realizing the functionalities of a DVR STB or CPE. In one implementation, a CPE 106 has programming content, which is encrypted, stored in storage therein. The first device 106a receives a request from another device 106b for accessing the programming content. The request includes a data package stored in association with the encrypted programming content in the storage. In response to the request, the first device 106a determines that the second device 106b is allowed to access the programming content based on information (e.g., usage rights information) in the first data package. Access is thereby granted.

So-called “DCAS” systems (downloadable conditional access systems) may also be used consistent with the disclosure in order to define/enforce trusted domains within the premises network 201. See, e.g., the exemplary DCAS apparatus and methods described in co-owned and co-pending U.S. patent application Ser. No. 11/584,208 entitled “DOWNLOADABLE SECURITY AND PROTECTION METHODS AND APPARATUS” filed Oct. 20, 2006, incorporated herein by reference in its entirety.

The CPE 106 and/or gateway 107 may also contain a secure microprocessor (e.g., security processor; not shown) which supports the trusted domain (such as, e.g., the Time Warner Cable Authorized Service Domain (ASD)). The bridge device transfers content from the Authorized Service Domain (ASD) to the DRM license domain for content viewed on the various CPE 106. One exemplary ASD configuration useful with the present disclosure is described in co-owned and co-pending U.S. patent application Ser. No. 11/592,054 entitled “METHODS AND APPARATUS FOR PREMISES CONTENT DISTRIBUTION” filed Nov. 1, 2006, incorporated herein by reference in its entirety.

### Additional Features—

In a further variant, when a key generation is requested, the network determines whether any updates are needed. For example, the identification of a replacement device 106b may be indicative of a change in the demographic, psychographic, etc. profile of the subscriber. At that point, the transfer manager 206 or other network entity determines whether any targeted ads stored within the content to be transferred should be replaced.

Moreover. when the transfer is complete and/or during the transfer, the user's interaction with the content at the second device 106b is monitored. For example, a user may select to have all content transferred from the first device 106a to the second device 106b with the exception of a particular television series. Based on this information, the system may determine that the television series is no longer among content in which the user is interested. Modifications to the subscriber's profile are therefore made.

In one embodiment, the apparatus and methods disclosed in co-owned, co-pending U.S. patent application Ser. No. 12/414,576 filed on Mar. 30, 2009 and entitled “RECOMMENDATION ENGINE APPARATUS AND METHODS”, which is incorporated herein by reference in its entirety, may be utilized to monitor the user's interactions and update a user profile. As discussed therein, a mechanism for particularly selecting content to align with a user's preferences via a user profile (the latter which the viewer need not enter manually) is disclosed. The content provided to the user is compiled from various distinct sources, including, inter alia, DVR, broadcasts, VOD systems, start over systems, etc. A mechanism is provided to learn (and unlearn) the user's preferences and which content they are likely to enjoy based on actions taken with regard to the content. In another aspect, client applications are utilized to compile the playlist based on user-imputed as well as pre-programmed user profiles. In another embodiment, various feedback mechanisms are utilized to enable the client application to “learn” from the user's activities in order to update the user profile, and generate more finely tuned recommendations.

In yet another variant, a list comprising all of the content to be transferred is transmitted to a network entity (such as e.g., the transfer manager). The network entity evaluates the list to determine whether any of the content may be eligible for an upgrade. For example, if the replacement device 106b comprises an HD capable device, and the content being transferred thereto comprises only SD content, the transfer monitor 206 may notify the subscriber (at either the first or the second device) and identify those ones of content which, rather than being transferred from the first device 106a, should be replaced with upgraded content which is stored at the network.

The transfer manager 206 may similarly determine whether any content to be transferred contains errors and must be replaced.

In the event that storage may be limited at the second device 106b, it is further appreciated that one or more applications at the first and/or second device may enable a user to selectively prioritize individual ones of the content. In this manner, the user may ensure that the content is pulled over hierarchically. Additionally, one or more content may be selected for storage at e.g., a network entity such a personal video recorder (PVR). For example, the storage entity of co-owned, co-pending U.S. patent application Ser. No. 11/440,490 filed May 24, 2006 and entitled “PERSONAL CONTENT SERVER APPARATUS AND METHODS”, which is incorporated herein by reference in its entirety. As discussed therein, a “network DVR” or a “virtual DVR” maintained for the subscriber at the headend or other location outside of the subscriber premises. In another embodiment, all content storage is performed/maintained at a content server located at the MSO network 101 or other network.

It will be recognized that while certain aspects of the disclosure are described in terms of a specific sequence of steps of a method, these descriptions are only illustrative of the broader methods of the disclosure, and may be modified as required by the particular application. Certain steps may be rendered unnecessary or optional under certain circumstances. Additionally, certain steps or functionality may be added to the disclosed embodiments, or the order of performance of two or more steps permuted. All such variations are considered to be encompassed within the disclosure disclosed and claimed herein.

While the above detailed description has shown, described, and pointed out novel features of the disclosure as applied to various embodiments, it will be understood that various omissions, substitutions, and changes in the form and details of the device or process illustrated may be made by those skilled in the art without departing from the disclosure. The foregoing description is of the best mode presently contemplated of carrying out the disclosure. This description is in no way meant to be limiting, but rather should be taken as illustrative of the general principles of the disclosure. The scope of the disclosure should be determined with reference to the claims.

It will be appreciated that while certain steps and aspects of the various methods and apparatus described herein may be performed by a human being, the disclosed aspects and individual methods and apparatus are generally computerized/computer-implemented. Computerized apparatus and methods are necessary to fully implement these aspects for any number of reasons including, without limitation, commercial viability, practicality, and even feasibility (i.e., certain steps/processes simply cannot be performed by a human being in any viable fashion).

What is claimed is:

1. A method of providing content from a first subscriber device to a second subscriber device, the content being associated to the first subscriber device, and the method comprising:
based at least on the occurrence of a triggering event, requesting a transfer security element for the transfer of the content from the first to the second subscriber device;
receiving the transfer security element;
decrypting the content using a first security element which is specific to the first subscriber device;
re-encrypting the content using the transfer security element; and
transferring the content to the second subscriber device.

2. The method of claim 1, wherein the transfer security element comprises a transfer cryptographic key, the first security element comprises a key, and the second subscriber device is configured to decrypt the content using the transfer cryptographic key, and re-encrypt the content using a second key which is specific to the second subscriber device.

3. A consumer premises device (CPE) configured to provide protected content to a client device in communication, the CPE comprising:
a first interface configured to receive the protected content from a network;
a storage device;
a second interface capable of data communication with the client device'
a processor in data communication with the storage device and the first and second interfaces and configured to execute at least one computer application thereon, the computer application comprising a plurality of instructions which are configured to, when executed by the processor:
based on satisfying a triggering criterion, request a transfer key from a network entity;
receive the transfer key;
decrypt the content using a first key which is specific to the CPE;
re-encrypt the content using the transfer key; and
transfer the protected content to the client device.

4. A method of providing content from a first subscriber device to a second subscriber device, the method comprising:
receiving a request to generate a content transfer key from the first subscriber device;
authenticating the first subscriber device;
creating the content transfer key; and
enabling the first subscriber device to access the content transfer key.

5. The method of claim 4, wherein the first subscriber device is configured to use the content transfer key to transcrypt the content from a first format that is specific to the first subscriber device, to a second format, the second format comprising a transfer format.

6. The method of claim 4, further comprising:
receiving a request to access the content transfer key from the second subscriber device;
authenticating the second subscriber device; and
enabling the second subscriber device to access the content transfer key.

7. The method of claim 6, wherein the second subscriber device is configured to use the content transfer key to transcrypt the content from the second format to a third format specific to the second subscriber device.

8. A content transfer manager apparatus configured to enable content to be transferred from a first device to a second device, the content transfer manager apparatus comprising:
a first interface configured to receive the content from a content source;
a storage device;
a digital processor, the processor in data communication with the storage device and first interface and configured to execute at least one computer program thereon, the computer program comprising a plurality of instructions which are configured to, when executed:
receive a request to generate a content transfer key from the first device;
authenticate the first device;
create the content transfer key; and
enable the first device to access the content transfer key.

9. The content transfer manager apparatus of claim 8, wherein the first device is configured to use the content transfer key to transcrypt the content from a first format specific to the first device, to a second format, the second format comprising a transfer format.

10. The content transfer manager apparatus of claim 8, wherein the plurality of instructions are further configured to, when executed: enable delivery of information regarding the content transfer key to the first client device.

11. The content transfer manager apparatus of claim 8, wherein the plurality of instructions are further configured, to when executed:
receive a request to access the content transfer key from the second client device;
authenticate the second client device; and
enable the second client device to access the content transfer key.

12. The content transfer manager apparatus of claim 11, wherein the second client device is configured to use the content transfer key to transcrypt the content from the second format to a third format specific to the second client device.

13. A method of receiving a plurality of content from a first user device at a second user device, the method comprising:
receiving the plurality of content in a first format, the first format comprising a transfer format;
requesting a transfer key from a network entity;
after authentication of the second user device, receiving the transfer key;
using the transfer key to decrypt the plurality of content; and
re-encrypting the plurality of content using a key which is specific to the second user device.
